(19) United States
(12) Patent Application Publication
(10) Pub. No.: US 2014/0315604 A1
(43) Pub. Date: Oct. 23, 2014

(54) CHARGING DEVICE AND CHARGED DEVICE

(71) Applicant: Yasushi Miyake, Osaka (JP)

(72) Inventor: Yasushi Miyake, Osaka (JP)

(21) Appl. No.: 14/117,186

(22) PCT Filed: Mar. 7, 2012
(86) PCT No.: PCT/JP2012/001560

§ 371 Date: Nov. 12, 2013

(30) Foreign Application Priority Data
Nov. 28, 2011 (JP) 2011-258971

(51) Int. Cl. H04B 1/38

(52) U.S. Cl. CPC H04B 1/3883
USPC 455/573

(57) ABSTRACT

A recorder (100) comprises a non-contact charging module (160) that supplies power to a smart phone (200), a WiFi module (170) that communicates with the smart phone (200), and a microprocessor (130) that sends the smart phone (200) charging information indicating whether or not the non-contact charging module (160) is supplying power to the smart phone (200), upon receipt of an inquiry from the smart phone (200).

### TECHNICAL FIELD

The present invention relates to a charging device, and more particularly relates to a charging device that can charge an external device. The present invention also relates to a charged device, and more particularly relates to a charged device that receives charging from an external device.

### BACKGROUND ART

Patent Literature 1 relates to a contact-free charging device that is capable of charging a portable telephone terminal without any contacts. This contact-free charging device uses a planar coil to send charging power to the portable telephone terminal without any contacts. This contact-free charging device performs, prior to sending power to the portable telephone terminal, authentication of the portable telephone terminal by using authorization of charging power transmission and an authentication-use information signal for authorizing data distribution to the portable telephone terminal. After authentication, this contact-free charging device sends the portable telephone terminal charging exchange distribution data that has been readied in advance. After this, the contact-free charging device sends charging power to the portable telephone terminal.

Consequently, this contact-free charging device can charge a portable telephone terminal without using an AC adapter or connector. Also, since this contact-free charging device performs data distribution to the portable telephone terminal on the basis of an authentication-use information signal, no data that is not needed by the user of the portable telephone terminal will be distributed. Also, since this contact-free charging device exchanges data distribution for the transmission of charging power, there is no need for equipment for calculating complicated electricity fees, thus allowing charging power to be supplied to the portable telephone terminal without encountering the drawback to power supply.

### CITATION LIST

### Patent Literature

Patent Literature 1: Japanese Laid-Open Patent Application 2008-295191

### SUMMARY

### Technical Problem

The contact-free charging device disclosed in the above-mentioned Patent Literature 1 uses a planar coil that transmits charging power, to send an information signal needed for authorization. Therefore, with the contact-free charging device disclosed in Patent Literature 1, there is no difference between the device being charged with power and the device to which data is sent.

Nevertheless, when contact-free charging is performed via a planar coil, while the transmission of data is performed via a separate system from the planar coil, there may be times when the device being charged and the device to which data is sent end up being different.

It is an object of the present invention to provide a charging device that is capable of receiving data from only a charged device which is being charged by the charging device. It is another object of the present invention to provide a charged device that is capable of sending data to only a charging device that is charging the charged device.

### Solution to Problem

To solve the above problems, the charging device pertaining to the present invention comprises a charging component configured to supply power to an external device, a communication component configured to communicate with the external device, and a controller configured to, when receiving an inquiry from the external device via the communication component, control the communication component so that charging information indicating whether or not the charging component is supplying power is sent to the external device from which the inquiry has been received.

Also, the charged device pertaining to the present invention comprises a charged component configured to receive a supply of power from an external device, a communication component configured to communicate with the external device, a memory configured to store content, and a controller configured to control the communication component so that some or all of the content stored in the memory is sent to the external device according to charging information acquired from the external device via the communication component and indicating whether or not the external device is supplying power.

### Advantageous Effects

The present invention provides a charging device that is capable of receiving data from only a charged device that is being charged by the charging device. The present invention also provides a charged device that is capable of sending data to only a charging device that is charging the charged device.

### BRIEF DESCRIPTION OF DRAWINGS

FIG. 1 is an oblique view of a recorder and smart phone in Embodiment 1;

FIG. 2 is a block diagram of the recorder and smart phone in Embodiment 1;

FIG. 3 is a flowchart of the control of the recorder in Embodiment 1;

FIG. 4 illustrates a charging state flag and charging start time in Embodiment 1;

FIG. 5 is a flowchart of the control of the recorder in Embodiment 1;

FIG. 6 is a flowchart of the control of the smart phone in Embodiment 1;

FIG. 7 is a flowchart of an operating example of the recorder and smart phone in Embodiment 1; and

FIG. 8 is an example of the display on the screen of the smart phone in Embodiment 1.

### DESCRIPTION OF EMBODIMENTS

Embodiment 1 of applying the present invention to a recorder and a smart phone will be described through reference to the drawings.

### 1. Embodiment 1

### 1-1. Overview

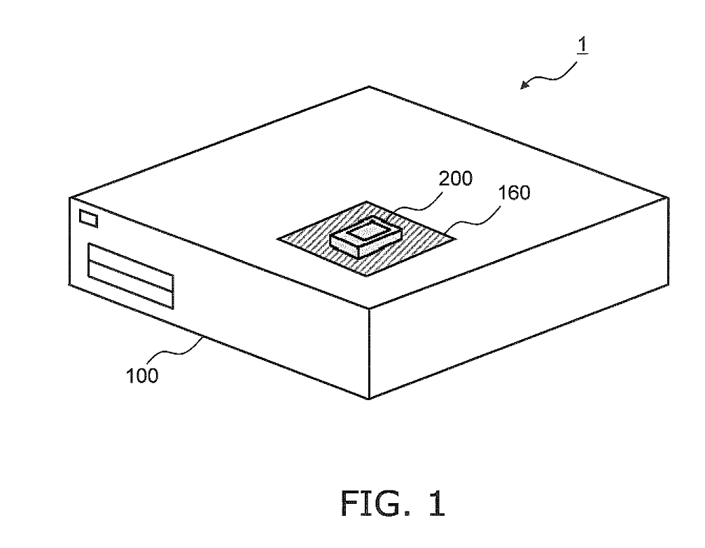

An overview of the embodiment will be described through reference to FIG. 1. FIG. 1 is an oblique view of a charging system 1 pertaining to this embodiment. The charging system 1 is constituted by a recorder 100 and a smart phone 200. The recorder 100 is one that stores image data and other such data. The smart phone 200 is also one that stores image data and other such data. The recorder 100 is capable of performing non-contact charging of a battery included in the smart phone 200 via a non-contact charging module 160.

The recorder 100 is also capable of receiving image data and other such data stored in the smart phone 200 by wireless LAN communication with the smart phone 200. The recorder 100 is capable of recording data received from the smart phone 200 on an internal hard disk drive.

The recorder 100 receives image data and other such data from only the smart phone 200 being charged by the recorder 100. The smart phone 200 sends image data and other such data to only the recorder 100 that is charging the smart phone 200.

The recorder 100 is an external device for the smart phone 200, and the smart phone 200 is an external device for the recorder 100.

### 1-2. Configuration

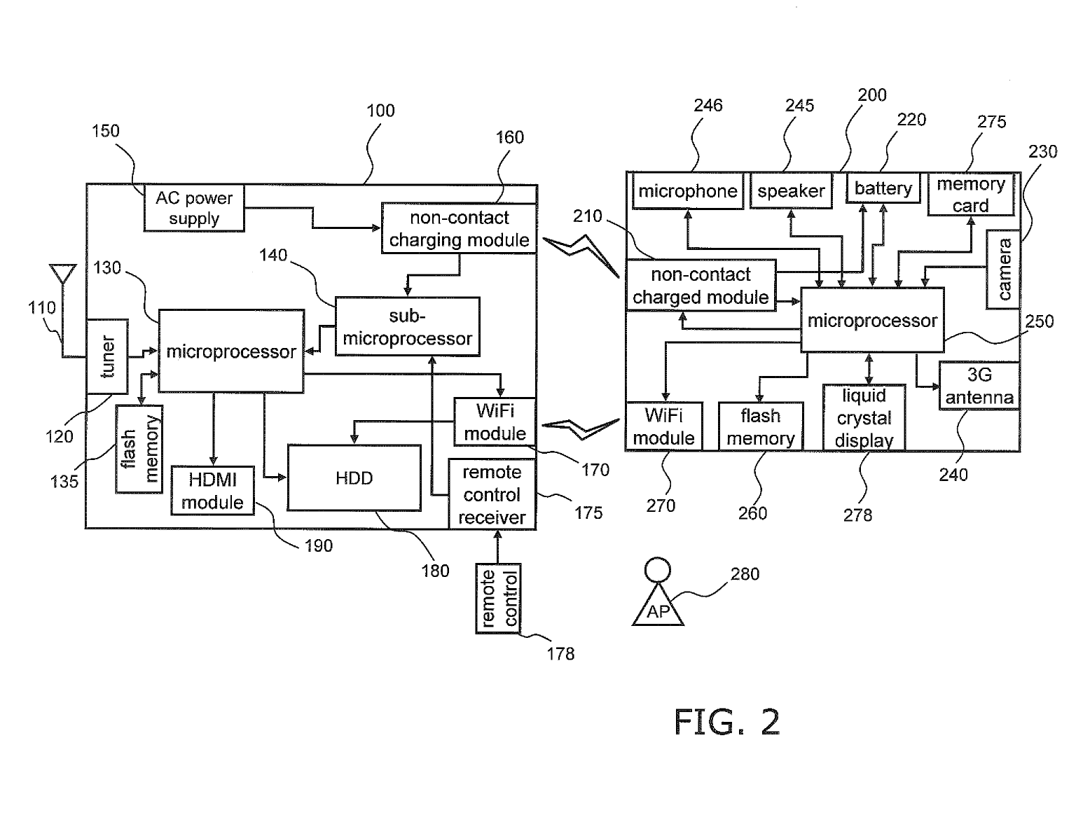

The configuration of the recorder 100 pertaining to this embodiment will be described through reference to FIG. 2. FIG. 2 is a block diagram of the configuration of the recorder 100 and the smart phone 200.

The recorder 100 receives broadcasts via an antenna 110. The recorder 100 produces moving image data by subjecting a received broadcast to compression or various other kinds of image processing with a microprocessor 130. The recorder 100 records the moving image data thus produced to a HDD 180. The recorder 100 also subjects the moving image data recorded to the HDD 180 to decoding and various other kinds of image processing with the microprocessor 130. The recorder 100 outputs the decoded data through an HDMI module 190 to an external television set or the like. The recorder 100 also sends power acquired via an AC power supply 150 through the non-contact charging module 160 to battery of the smart phone 200 or other external device.

The smart phone 200 communicates with other smart phones, etc., via a 3G antenna 240. The smart phone 200 subjects audio received from another smart phone or the like via the 3G antenna 240 to various kinds of processing with a microprocessor 250. The smart phone 200 outputs the processed audio from a speaker 245. The smart phone 200 subjects the audio received via a microphone 246 to various kinds of processing with the microprocessor 250. The smart phone 200 sends the processed audio data through the 3G antenna 240 to another smart phone or the like. The smart phone 200 also produces moving image data by subjecting the image data captured by a camera 230 to compression and various other kinds of image processing with the microprocessor 250. The smart phone 200 records the moving image data thus produced to a memory card 275. The smart phone 200 charges a battery 220 with power received from an external device via a non-contact charged module 210.

The configurations of the recorder 100 and the smart phone 200 will now be described in detail. First, the recorder 100 will be described in detail.

1-2-1. Configuration of Recorder 100

The recorder 100 comprises the antenna 110, a tuner 120, the microprocessor 130 (an example of a controller), a flash memory 135, a sub-microprocessor 140, the AC power supply 150, the non-contact charging module 160 (an example of a charging component), a WiFi module 170 (an example of a communication component), a remote control receiver 175, a remote control 178, the HDD 180, and the HDMI module 190.

The antenna 110 is one that receives broadcasts from a broadcast station. The antenna 110 is constituted by a parabolic antenna or the like for receiving BS/CS digital broadcasts or a UHF antenna for receiving ground digital broadcasts.

The tuner 120 extracts the channel tuned to by the user from among the radio waves received by the antenna 110. The tuner 120 produces digital data that can be processed by the microprocessor 130, on the basis of the extracted radio waves.

The microprocessor 130 is a control module that controls the entire recorder 100. In this embodiment, the microprocessor 130 is constituted by an SOC (system-on-chip). Therefore, the microprocessor 130 is such that a CPU, a memory, and a data signal processing circuit are integrally configured. The microprocessor 130 is constituted by a high-performance semiconductor, and has good processing performance. On the other hand, the microprocessor 130 consumes a large amount of power. Accordingly, the microprocessor 130 is shut off except when using main functions such as television broadcast recording or network communication.

The flash memory 135 is a nonvolatile and rewritable semiconductor memory. The flash memory 135 stores various kinds of control programs, the operating system (OS) needed for the operation of the recorder 100, and so forth. At start-up, the microprocessor 130 reads the OS and so forth stored in the flash memory 135. The microprocessor 130 expands the read OS and so forth into the memory inside the microprocessor 130, and they are executed by the CPU inside the microprocessor 130.

The sub-microprocessor 140 differs from the microprocessor 130 in that it is always operating as long as the AC power supply 150 is plugged in to an outlet. The sub-microprocessor 140 has a lower processing capacity than the microprocessor 130, and therefore consumes less power. The sub-microprocessor 140 includes functions such as timer recording for the recorder 100, and therefore has a clock and a time schedule for actuating the microprocessor 130 internally. The sub-microprocessor 140 issues an actuate command to the microprocessor 130 at the point when the internal clock indicates the next actuation time of the microprocessor 130. The sub-microprocessor 140 also issues an actuate command to the microprocessor 130 if the non-contact charging module 160 has started sending power to an external device. The sub-microprocessor 140 also issues an actuate command to the microprocessor 130 if an actuation command is received via the remote control receiver 175.

The AC power supply 150 receives the supply of power from an outlet of a household power supply. The non-contact charging module 160 receives the supply of power from the AC power supply 150. The non-contact charging module 160 is a charging module that supplies power to the non-contact charged module 210 of the charged device (the smart phone 200 in this embodiment) by electromagnetic induction. The non-contact charging module 160 is capable of detecting that a charged device has moved close to the non-contact charging module 160. The non-contact charging module 160 starts charging the charged device in response to the detection of the proximity of the charged device. The non-contact charging module 160 also sends the sub-microprocessor 140 a charging start signal indicating that the charging of the charged device has begun. The non-contact charging module 160 conforms to the “Qi” standard, which is an international standard for wireless power supply.

The WiFi module 170 is a communication module capable of wireless LAN communication. The WiFi module 170 conforms to the “IEEE 802.11” standard, which is an international standard for wireless LAN communication. The WiFi module 170 is capable of communicating with a WiFi module 270 of the smart phone 200 using by IP (Internet protocol). The WiFi module 170 is also capable of communicating with an in-home device, etc., via an access point 280 using IP.

The remote control receiver 175 receives a control signal modulated to infrared rays or RF rays send from the remote control 178. For example, the remote control receiver 175 receives control signals for power on/off, channel changing, recording start/stop, and so forth. The remote control receiver 175 converts the received control signals into digital signals that can be understood by the sub-microprocessor 140.

The remote control 178 is an interface device that the user uses to operate the recorder 100 remotely. Various buttons are provided to the remote control 178. The user presses the buttons on the remote control 178 to remotely operate the recorder 100.

The HDD 180 is a memory device that stores moving image data or the like. The HDD 180 stores moving image data indicating a broadcast program received through the antenna 110, image data received from the smart phone 200 or another external device via the WiFi module 170, and other such data.

The HDMI module 190 is an interface that connects the recorder 100 to a television or other external device. The recorder 100 is capable of outputting moving pictures indicated by the moving image data stored in the HDD 180, to an external device via the HDMI module 190.

1-2-2. Configuration of Smart Phone 200

Next, the configuration of the smart phone 200 will be described in detail. The smart phone 200 comprises the non-contact charged module 210 (an example of a charged component), the battery 220, the camera 230, the 3G antenna 240, the speaker 245, the microphone 246, the microprocessor 250 (an example of a controller), a flash memory 260, the WiFi module 270 (an example of a communication component), the memory card 275 (an example of a memory), and a liquid crystal display 278 (an example of a display component).

The non-contact charged module 210 is a charged module that receives a supply of power from the non-contact charging module 160 by electromagnetic induction. The non-contact charged module 210 is capable of charging the battery 220 with the received power. As soon as it starts charging the battery 220, the non-contact charged module 210 sends the microprocessor 250 a signal indicating the start of charging of the battery 220. The non-contact charged module 210 is similar to the non-contact charging module 160 in that it conforms to the “Qi” standard, which is an international standard for wireless power supply.

The battery 220 is a power supply that supplies electric power to the various modules of the smart phone 200. In this embodiment, the battery 220 is constituted by a lithium ion battery. The battery 220 stores power received from the non-contact charging module 160 via the non-contact charged module 210.

The camera 230 is an imaging component that includes an optical system and a CMOS image sensor internally. Image data captured by the camera 230 is subjected to compression and other such processing by the microprocessor 250, and recorded to the memory card 275.

The 3G antenna 240 is a communication module that communicates with a portable telephone base station. In this embodiment, the 3G antenna 240 conforms to the 3G standard. The 3G antenna 240 is used for data communication and conversation via a portable telephone network.

The speaker 245 outputs audio indicated by the audio data received via the 3G antenna 240. The microphone 246 receives the input of audio emitted by the user. The microphone 246 converts the received audio into audio data and sends it to the microprocessor 250. The microprocessor 250 subjects the audio data to compression or various other kinds of processing, and sends it through the 3G antenna 240 to a portable telephone base station.

The microprocessor 250 is a control module that controls the various modules inside the smart phone 200. In this embodiment, the microprocessor 250 is constituted by an SOC, just as is the microprocessor 130. The microprocessor 250 reads the operating system, control programs, etc., stored in the flash memory 260 upon start-up.

The WiFi module 270 is a communication module capable of wireless LAN communication. The WiFi module 270 conforms to the “IEEE 802.11” standard, which is an international standard for wireless LAN communication.

The liquid crystal display 278 is a display that displays images. The liquid crystal display 278 is equipped with a touch panel function. Therefore, the user can operate the smart phone 200 via the liquid crystal display 278.

### 1-3. Operation

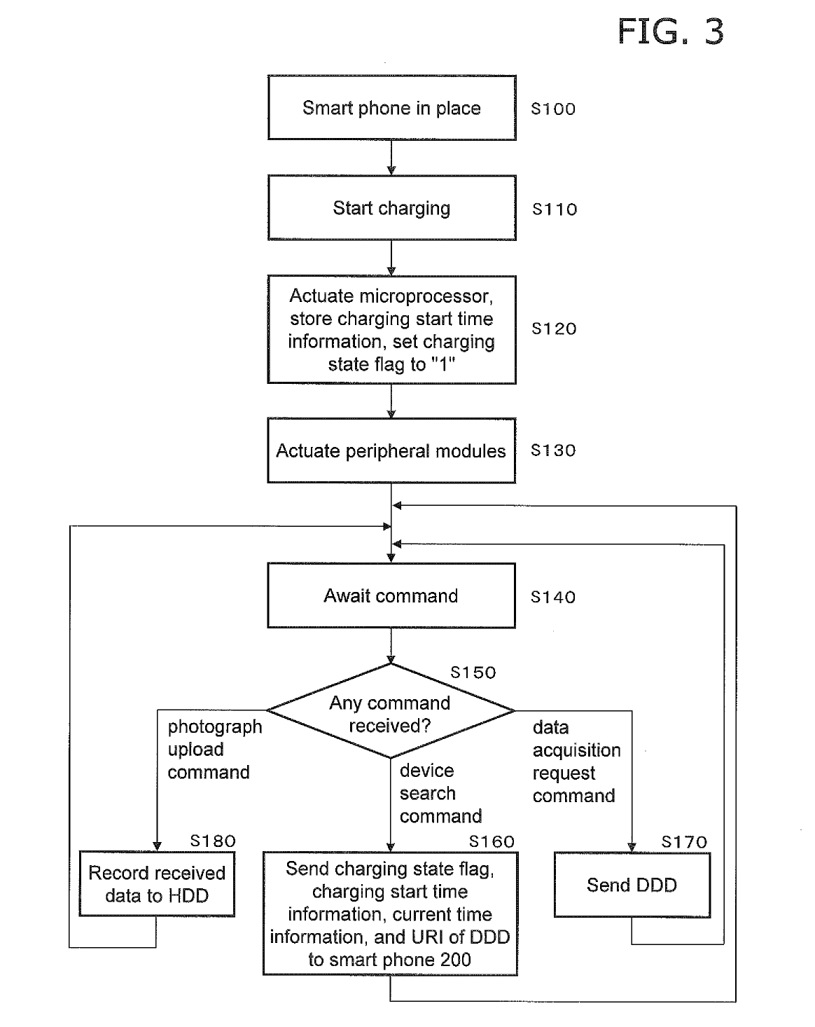

Next, the operation of the recorder 100 and the smart phone 200 will be described through reference to FIGS. 3 to 6.

1-3-1. Operation of Recorder 100 (when Smart Phone 200 is Placed on Non-Contact Charging Module 160)

First, the operation of the recorder 100 when the smart phone 200 has been placed on the non-contact charging module 160 in a state in which power to the recorder 100 is off will be described through reference to FIG. 3. FIG. 3 is a flowchart illustrating the operation of the recorder 100.

When the smart phone 200 is placed on the non-contact charging module 160 (S100), the non-contact charging module 160 starts charging the battery 220 via the non-contact charged module 210 (5110). When charging begins, the non-contact charging module 160 sends a charging start signal to the sub-microprocessor 140. Upon receiving the charging start signal, the sub-microprocessor 140 issues an actuation command to the microprocessor 130, and actuates the microprocessor 130 (S120). Also, upon receiving the charging start signal, the sub-microprocessor 140 stores information related to the time when the charging start signal was received (hereinafter referred to as “charging start time information”) in an internal memory (S120). Also, upon receiving the charging start signal, the sub-microprocessor 140 sets a charging state flag in the internal memory, which is a flag indicating whether or not power is being supplied to the smart phone 200, to “1” (S120).

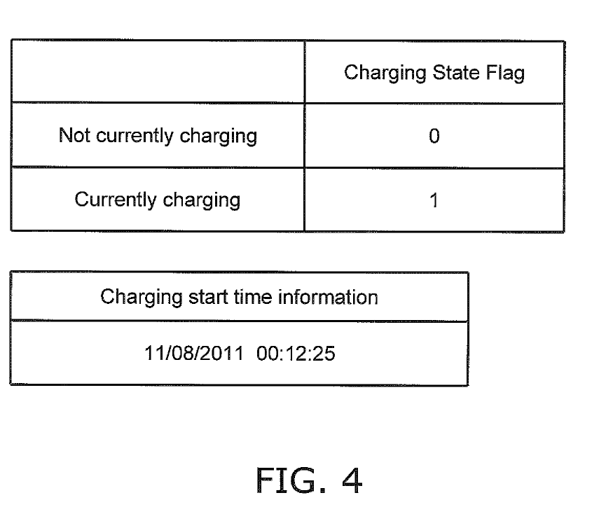

The charging start time information and the charging state flag stored in the internal memory of the sub-microprocessor 140 in step S120 will now be described through reference to FIG. 4. FIG. 4 is a simplified diagram illustrating the charging start time information and the charging state flag. If the smart phone 200 is not being charged by the recorder 100, “0” is set for the charging state flag in the internal memory of the sub-microprocessor 140. On the other hand, if the smart phone 200 is being charged by the recorder 100, “1” is set for the charging state flag in the internal memory of the sub-microprocessor 140. When the charging of the smart phone 200 by the non-contact charging module 160 begins, the sub-microprocessor 140 stores the charging start time information into the internal memory. More specifically, the sub-microprocessor 140 stores information consisting of year/month/day/hour/minutes/seconds as the charging start time information in the internal memory.

When an actuation command is received in step S120, the microprocessor 130 directs the HDD 180 and other peripheral modules to be actuated (S130). When having directed the peripheral modules to be actuated, the microprocessor 130 confirms that the peripheral modules have been actuated, and then actuates a DLNA (Digital Living Network Alliance) server function. After this, the microprocessor 130 waits until a command is received from the smart phone 200 via the WiFi module 170 (S140).

The DLNA will now be described. DLNA is a communication standard provided so that photograph, music, video data and the like can be shared between in-home devices using an IP network. With DLNA, first a client device sends a device search command to a server, and the server responds to the received device search command. This allows the client device and the server to recognize each other for communication. The data sent by the server in response to the client device includes the IP address of the server, and the URI (uniform resource identifier) of the DDD (device description document) for identifying the functions performable by the server.

If determining that a device search command has been received in a state of waiting for the receipt of a command in step S140 (S150), the microprocessor 130 controls the sub-microprocessor 140 so that the URI of the DDD, information related to the current time (hereinafter referred to as “current time information”), charging start time information, and the charging state flag stored in the internal memory of the sub-microprocessor 140 as “charging information” indicating whether or not power is being supplied, are sent through the WiFi module 170 to the smart phone 200 (S160). That is, the microprocessor 130 sends “1” as the charging state flag to the smart phone 200, sends the charging start time information to the smart phone 200, and sends the current time information to the smart phone 200. The smart phone 200 refers to the charging state flag, the charging start time information, and the current time information to recognize that the recorder 100 is the external device that is charging the smart phone 200 (hereinafter referred to as the “charging device”). The method by which the smart phone 200 recognizes that the recorder 100 is the device charging the smart phone 200 on the basis of the charging state flag, the charging start time information, and the current time information will be discussed below.

If determining that a data acquisition request command has been received in a state of waiting for the receipt of a command in step S140 (S150), the microprocessor 130 sends the DDD through the WiFi module 170 to the smart phone 200. The DDD indicates whether or not the recorder has a photograph upload function, a recorded program transmission function, etc. The smart phone 200 recognizes the capability of the recorder 100 by acquiring the DDD.

If determining that a photograph upload command has been received in a state of waiting for the receipt of a command in step S140 (S150), the microprocessor 130 records the image data received from the smart phone 200 via the WiFi module 170 to the HDD 180 (S180).

Thus, in this embodiment, when having received a device search command from the smart phone 200, the recorder 100 sends the smart phone 200 a charging state flag indicating whether or not the non-contact charging module 160 is supplying power to the smart phone 200. This allows the recorder 100 to inform the smart phone 200 either that it is a device in the midst of charging the smart phone 200, or that it is not a device in the midst of charging the smart phone 200. As a result, there is a greater probability that the smart phone 200 can send data to only the charging device that is charging the smart phone 200, and that the recorder 100 can receive data from only the device being charged by the recorder 100.

1-3-2. Operation of Recorder 100 (when Smart Phone 200 is not Placed on Non-Contact Charging Module 160)

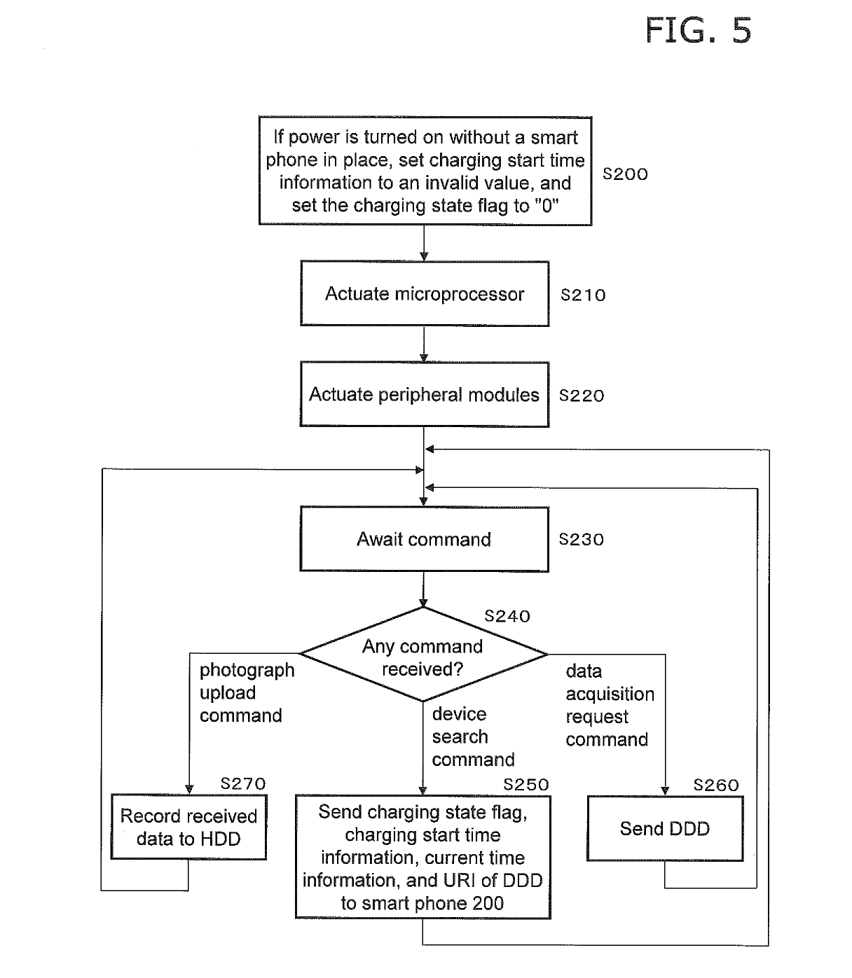

Next, the operation of the recorder 100 when its power has been switched on in a state in which the smart phone 200 has not been placed on the non-contact charging module 160 will be described through reference to FIG. 5. FIG. 5 is a flowchart illustrating the operation of the recorder 100.

When the user presses the power ON button of the remote control 178 in a state in which the smart phone 200 has not been placed on the non-contact charging module 160, the remote control receiver 175 outputs a power ON command to the sub-microprocessor 140. When receiving the power ON command, the sub-microprocessor 140 sets the charging state flag to “0,” and sets invalid values (such as 00/00/00 00:00:00) for the charging start time (S200).

When having set the various kinds of information, the sub-microprocessor 140 issues an actuation command to the microprocessor 130, and actuates the microprocessor 130 (S210). Steps S210 to S240, step S260, and step S270 are the same operations as in steps S120 to S150, step S170, and step S180 in FIG. 3, respectively. Only step S250 differs from step S160 in FIG. 3.

The operation in step S250 will be described. If determining that a device search command has been received in a state of waiting for the receipt of a command in step S230 (S240), the microprocessor 130 controls the sub-microprocessor 140 so as to send the current time information, the charging start time information, and the charging state flag stored in the internal memory of the sub-microprocessor 140, through the WiFi module 170 to the smart phone 200 (S250). That is, the microprocessor 130 sends “0” as the charging state flag to the smart phone 200, sends an invalid value as the charging start time information to the smart phone 200, and sends the current time information (S250).

1-3-3. Operation of Smart Phone 200

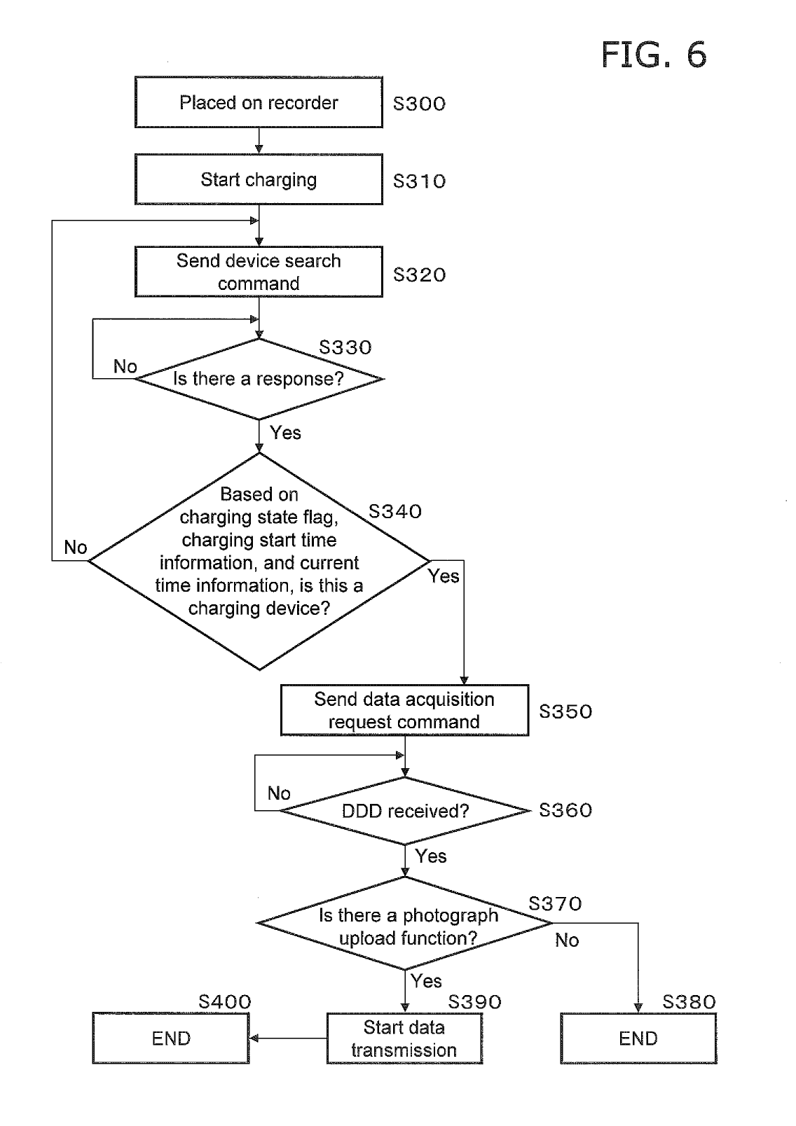

Next, the operation of the smart phone 200 will be described through reference to FIG. 6. FIG. 6 is a flowchart illustrating the operation of the smart phone 200.

The user places the smart phone 200 on the non-contact charging module 160 of the recorder 100 (S300). When the smart phone 200 is placed on the non-contact charging module 160, the non-contact charged module 210 starts charging the battery 220 with the power received via the non-contact charging module 160 (S310). When charging begins, the non-contact charged module 210 notifies the microprocessor 250 that charging of the battery 220 has begun. Upon receiving this notification of the start of charging, the microprocessor 250 records information related to the time when the notification of the start of charging was received (hereinafter referred to as “charged start time information”) in the internal memory. When the charged start time information is recorded in the internal memory, the microprocessor 250 sends a device search command through the WiFi module 270 to the external device (S320).

When having sent the device search command, the microprocessor 250 waits until there is a response from the external device (S330). When having received a response from the external device (including the URI of the DDD and charging information), the microprocessor 250 determines whether or not the external device from which t the response has been received is a charging device that is charging the smart phone 200, on the basis of the current time information, the charging start time information, and the charging state flag (the response contents) (S340). More specifically, if the charging state flag in the received response is “1,” and if the difference between the current time received in the response and the charging start time received in the response (that is, the elapsed charging time) is the same or substantially the same as the difference between the charged start time stored in the internal memory of the microprocessor 250 and the current time indicated by the internal clock (that is the elapsed charged time), then the microprocessor 250 determines that the external device at the transmission destination is a charging device in the midst of charging the smart phone 200. On the other hand, if the above conditions are not met, the microprocessor 250 determines that the external device from which the response was received is not a charging device in the midst of charging the smart phone 200.

If the external device from which the response has been received is determined not to be a charging device in the midst of charging the smart phone 200, then the microprocessor 250 goes back to step S320 and sends a device search command to another external device (S320).

On the other hand, if the external device from which the response has been received is determined to be a charging device in the midst of charging the smart phone 200, then the microprocessor 250 sends a data acquisition request command to the charging device by using the URI of the DDD (S350). Once the acquisition request command has been sent to the URI of the DDD, the microprocessor 250 waits until the DDD is received from the external device (S360).

When having received the DDD, the microprocessor 250 determines whether or not the charging device is compatible with a photograph upload function (S370). If determining that the charging device does not have a photograph upload function, the microprocessor 250 continues the charging of the battery 220 from the non-contact charged module 210, without executing any special processing (S380). On the other hand, if determining that the external device has a photograph upload function, the microprocessor 250 sends a photograph or other image data stored on the memory card 275 through the WiFi module 270 to the recorder 100 (S390). When the transmission of the image data is complete, the microprocessor 250 continues the charging of the battery 220 from the non-contact charged module 210 (S400).

Thus, the smart phone 200 in this embodiment controls the WiFi module 270 so as to send the external device some or all of the image data stored on the memory card 275, according to the information related to the state of the external device acquired from the external device (at least a charging state flag). This allows the smart phone 200 to send data to only the charging device that is charging the smart phone 200.

### 1-4. Example of Operation of Recorder 100 and Smart Phone 200

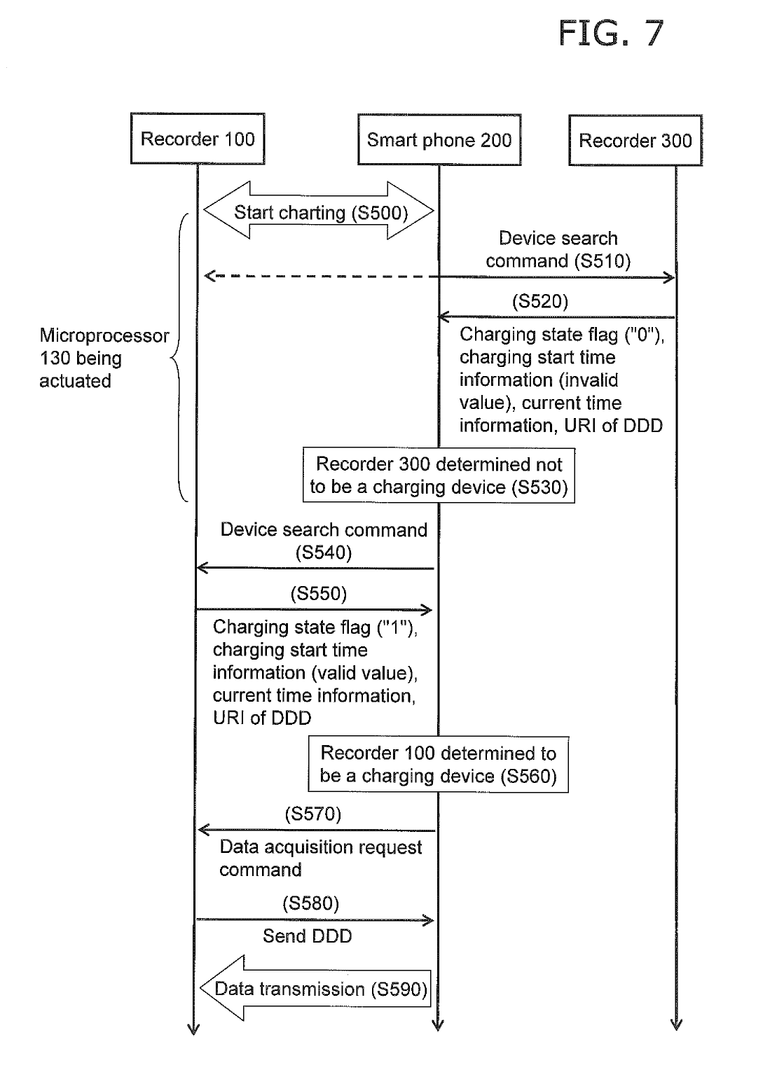

Next, an example of the operation of the recorder 100, the smart phone 200, and a recorder 300 will be given through reference to FIG. 7, for when the recorder 100 is charging the smart phone 200. FIG. 7 is a flowchart illustrating an example of the operation of the recorder 100, the smart phone 200, and the recorder 300.

If the smart phone 200 is placed on the non-contact charging module 160 when the power of the recorder 100 is off, the recorder 100 starts charging the smart phone 200 (S500). When charging by the recorder 100 begins, the smart phone 200 sends a device search command by broadcast communication (S510). At this stage, the microprocessor 130 of the recorder 100 is still in the midst of being started up, and the start-up is not complete. This start-up takes approximately 1 minute. The start-up of the recorder 300 is complete at this stage. In this state, the recorder 300, which has completed its start-up, receives the device search command.

When having received the device search command, the recorder 300 sends a charging state flag (“0” is set), an invalid value set as the charging start time information, the current time information, and the URI of the DDD to the smart phone 200 (S520). As a result, the smart phone 200 recognizes that the recorder 300 is not a charging device that is charging the smart phone 200 (S530).

Upon recognizing that the recorder 300 is not a charging device that is charging the smart phone 200, the smart phone 200 sends a device search command to the recorder 100, which is another external device (S540). Upon receiving the device search command, the recorder 100 sends a charging state flag (“1” is set), the charging start time information (a valid value set in the internal memory of the sub-microprocessor 140), the current time information, and the URI of the DDD to the smart phone 200 (S550). As a result, the smart phone 200 recognizes that the recorder 100 is an external device that is charging the smart phone 200 (S560).

If having recognized that the recorder 100 is a charging device that is charging the smart phone 200, the smart phone 200 sends a data acquisition request command to the recorder 100 (S570). Upon receipt of the data acquisition request command, the recorder 100 sends a DDD (indicating that it has a photograph upload function) to the smart phone 200 (S580). Consequently, the smart phone 200 recognizes that the recorder 100 is compatible with a photograph upload function.

If having recognized that the recorder 100 is compatible with a photograph upload function, the smart phone 200 sends a photograph or other such image data stored on the memory card 275 to the recorder 100 (S590).

Thus, with this embodiment, the smart phone 200 is capable of sending image data or other data to only the charging device that is charging the smart phone 200, and the recorder 100 can receive image data or other data from only the charged device that the recorder 100 is charging (the smart phone 200, in this embodiment).

### 2. Other Embodiments

Embodiment 1 was described above, but the present invention is not limited to Embodiment 1, and can be applied to various other embodiments. Examples of other embodiments will be described below.

(A) In Embodiment 1, an example was described in which the recorder 100 is a charging device, but this is not necessarily the only option. For example, the charging device may be a PC, a network attached storage, or other such device. In Embodiment 1, a case was described in which the recorder 100 charged the smart phone 200, but it is also possible for the recorder 100 to simultaneously charge a plurality of charged devices. In this case, the process discussed above is executed between the various charged devices.

(B) In Embodiment 1, the smart phone 200 was given as an example of a charged device, but this is not necessarily the only option. For example, the charged device can instead be a digital camera, a portable music player, a portable telephone, a charging pack, or the like.

(C) In Embodiment 1, the WiFi module 170 and the WiFi module 270 were given as examples of communication components, but these are not necessarily the only option. For example, a wired LAN, PLC, WiFi Direct, or the like can be used instead.

(D) In Embodiment 1, an example was given in which image data stored in the smart phone 200 was sent to the recorder 100, but this is not necessarily the only option. For example, the present invention can also be applied to when program data stored in the recorder 100 is sent to the recorder 100.

In this case, if the recorder 100 is supplying power, the microprocessor 250 of the smart phone 200 controls the WiFi module 270 so as to request the recorder 100 to send content, and if the recorder 100 is not supplying power, the WiFi module 270 should not be controlled so as to request the recorder 100 to send content.

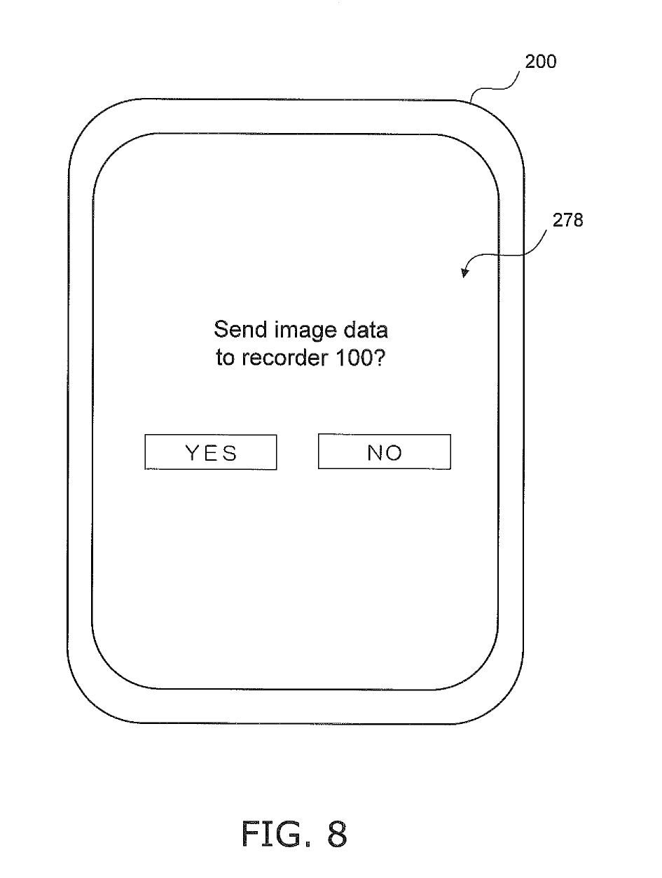

(E) In Embodiment 1, transmission of image data from the smart phone 200 was performed automatically after recognition that charging was being received from the recorder 100, but this is not necessarily the only option. For example, the smart phone 200 may ask the user whether or not the transfer of content is permitted after recognition of receiving charging from the recorder 100. More specifically, the smart phone 200 may be equipped with an image controller that displays an image prompting a user to give a content transmission instruction as shown in FIG. 8 if it is recognized that charging is being received from the recorder 100. In this case, the microprocessor 250 sends some or all of the content to the recorder 100 only if a transmission instruction from the user has been received at the touch panel of the liquid crystal display 278. This allows image data to be transferred only when necessary. The above-mentioned image controller may be included in the microprocessor 250.

(F) In Embodiment 1, the recorder 100 sent the smart phone 200 a charging state flag, charging start time information, and current time information as charging information indicating whether or not the recorder 100 (the non-contact charging module 160) was supplying power, but the charging information is not necessarily limited to this example.

For instance, the recorder 100 may send the smart phone 200 just a charging state flag as charging information. In this case, the smart phone 200 will recognize the recorder 100 as a charging device if the charging state flag is “1.”

Also, the recorder 100 may send the smart phone 200 just charging start time information and current time information as the charging information. Furthermore, the recorder 100 may send the smart phone 200 just the difference between the charging start time and the current time (that is, the elapsed charging time) as the charging information. A set comprising charging start time information, current time information, and the elapsed charging time is an example of time information related to charging. In this case, the smart phone 200 can recognize that the recorder 100 is the charging device by just receiving the time information related to charging. It can be determined even more accurately that the recorder 100 is the charging device supplying power to the smart phone 200 by comparing the received elapsed charging time and the elapsed charged time within the smart phone 200.

Also, the recorder 100 may use remaining capacity information related to the remaining capacity of the battery inside the smart phone 200 as the charging information. That is, the recorder 100 receives remaining capacity information from the smart phone 200 via the non-contact charging module 160, and sends the received remaining capacity information to the smart phone 200 via the WiFi module 170. This allows the smart phone 200 to recognize that the recorder 100 is the charging device merely by receiving remaining capacity information. Furthermore, whether or not the recorder 100 is the charging device supplying power to the smart phone 200 can be determined more accurately by comparing the received remaining capacity information with information about the remaining capacity of the battery inside the smart phone 200.

Thus, charging information may include one or more of a charging state flag, time information related to charging (a set comprising charging start time information, current time information, and the elapsed charging time), and remaining capacity information. The more information is included in the charging information, the more accurately the smart phone 200 can determine whether or not the recorder 100 is the charging device supplying power to the smart phone 200.

(G) In Embodiment 1, the recorder 100 performed wireless communication with the smart phone 200 while performing non-contact charging of the smart phone 200, but this is not the only option. The present invention can also be applied to a case in which the charging path and the communication path are split into two systems. Therefore, the recorder 100 may perform contact charging of the smart phone 200 (such as charging through a cable), or may perform wired communication with the smart phone 200.

### Addenda

Other features of the present invention are appended below.

(i) The charged device pertaining to the present invention comprises a charged component that receives a supply of power from an external device, a communication component that communicates with an external device, a memory that stores content, a display component that displays images, an image display component that displays on the display component an image prompting an instruction to the external device to send the content according to the details of charging information related to whether or not the external device is supplying power, acquired from the external device via the communication component, and a controller that controls the communication component so as to send some or all of the content stored in the memory to the external device according to the transmission instruction.

(ii) The charging system pertaining to the present invention comprises a charged device and a charging device. The charged device has a charged component capable of receiving a supply of power, a first communication component capable of communication, a memory that stores content, and a first controller that sends an inquiry from the first communication component when the charged component has received a supply of power. The charging device has a charging component capable of the non-contact supply of power, a second communication component capable of wireless communication, and a second controller that sends charging information indicating whether or not the charging component is supplying power, from the second communication component to the charged device, in response to the inquiry received via the second communication component. The first controller sends some or all of the content from the first communication component to the charging device when it is determined that the charging device is supplying power to the charged component, on the basis of the charging information received via the first communication component.

### INDUSTRIAL APPLICABILITY

The present invention can be applied to a recorder, a charging cradle, or another such charging device. The present invention can also be applied to a portable telephone, a smart phone, a digital camera, or another such charged device.

### REFERENCE SIGNS LIST

100 recorder
110 antenna
120 tuner
130 microprocessor
135 flash memory
140 sub-microprocessor
150 AC power supply
160 non-contact charging module
170 WiFi module
175 remote control receiver
178 remote control
180 HDD
190 HDMI module
200 smart phone
210 non-contact charged module
220 battery
230 camera
240 3G antenna
245 speaker
246 microphone
250 microprocessor
260 flash memory
270 WiFi module
275 memory card
278 liquid crystal display
280 access point

1. A charging device, comprising:
a charging component configured to supply power to an external device;
a communication component configured to communicate with the external device; and
a controller configured to, when receiving an inquiry from the external device via the communication component, control the communication component so that charging information indicating whether or not the charging component is supplying power is sent to the external device from which the inquiry has been received.

2. The charging device according to claim 1,
wherein the charging information includes at least one of a charging state flag indicating a charging state produced by the charging component, and time information related to charging by the charging component.

3. The charging device according to claim 1,
wherein the charging component is configured to receive from the external device remaining capacity information related to remaining capacity of a battery in the external device, and
the charging information includes the remaining capacity information.

4. A charged device, comprising:
a charged component configured to receive a supply of power from an external device;
a communication component configured to communicate with the external device;
a memory configured to store content; and
a controller configured to control the communication component so that some or all of the content stored in the memory is sent to the external device according to charging information supplied from the external device via the communication component and indicating whether or not the external device is supplying power.

5. The charged device according to claim 4,
wherein the charging information includes one or more of a charging state flag indicating a charging state produced by the external device, time information related to charging by the external device, and remaining capacity information related to remaining capacity of a battery to be charged inside the external device.

6. The charged device according to claim 4,
wherein, when the external device is supplying power, the controller controls the communication component so that some or all of the content stored in the memory is sent to the external device, and when the external device is not supplying power, the controller does not control the communication component so the content stored in the memory is sent to the external device.

7. The charged device according to claim 4,
wherein, when the external device is supplying power, the controller controls the communication component so as to request the external device to transmit content, and when the external device is not supplying power, the controller is prevented from controlling the communication component so as to request the external device to transmit content.

8. The charging device according to claim 2,
wherein the charging component is configured to receive from the external device remaining capacity information related to remaining capacity of a battery in the external device, and
the charging information includes the remaining capacity information.

9. The charged device according to claim 5,
wherein, when the external device is supplying power, the controller controls the communication component so that some or all of the content stored in the memory is sent to the external device, and when the external device is not supplying power, the controller does not control the communication component so the content stored in the memory is sent to the external device.

10. The charged device according to claim 5,
wherein, when the external device is supplying power, the controller controls the communication component so as to request the external device to transmit content, and when the external device is not supplying power, the controller is prevented from controlling the communication component so as to request the external device to transmit content.

11. The charged device according to claim 6,
wherein, when the external device is supplying power, the controller controls the communication component so as to request the external device to transmit content, and when the external device is not supplying power, the controller is prevented from controlling the communication component so as to request the external device to transmit content.
